(19) United States
(12) Patent Application Publication
(10) Pub. No.: US 2009/0313174 A1
(43) Pub. Date: Dec. 17, 2009

(54) Approving Energy Transaction Plans Associated with Electric Vehicles

(75) Inventors: James Lee Hafner, San Jose, CA (US); Melissa Wiltsey O'Mara, Tully, NY (US); Paul Stuart Williamson, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/139,571

(22) Filed: Jun. 16, 2008

(51) Int. Cl. G06Q 10/00

(52) U.S. Cl. 705/80

(57) ABSTRACT

A computer implemented method, apparatus, and computer program product for approving energy transaction plans for managing electric vehicle charging transactions. In one embodiment, an energy transaction plan and an identification of a set of principals associated with the energy transaction plan are received from an energy transaction planner. In response to a determination that the energy transaction plan is pre-approved by the set of principals, an energy transaction plan approval service sends a notification to the energy transaction planner indicating that the energy transaction plan is approved to form an approved energy transaction plan. In response to a determination that the energy transaction plan requires express approval from a subset of principals in the set of principals, the transaction plan approval service sends a request for approval of the energy transaction plan to each principal in the subset of principals. In response to receiving an approval from the each principal in the subset of principals, the transaction plan approval service sends the notification to the energy transaction planner indicating that the energy transaction plan is approved to form the approved energy transaction plan. The approved energy transaction plan is sent to an execution engine for implementation.

### BACKGROUND OF THE INVENTION

1. Field of the Invention

The present invention is related generally to an improved data processing system, and in particular, to a method and apparatus for managing electric vehicle charging transactions. More particularly, the present invention is directed to a computer implemented method, apparatus, and computer usable program code for approving energy transaction plans for managing electric vehicle charging transactions.

2. Description of the Related Art

Electric vehicles (EV) can be divided into two categories: totally electric vehicles (TEV) and plug-in hybrid electric vehicles (PHEV). Plug-in hybrid vehicles utilize two or more power sources to drive the vehicle. With the increasing costs of fossil fuels and concern over reliance on non-renewable resources, electric vehicles are poised to become a critical component of transportation systems throughout the world. Gasoline powered vehicles utilize the explosive power of a mixture of gasoline and air to propel the vehicle. In contrast, electric vehicles rely in whole or in part on electric power to drive the vehicle.

Electric vehicles contain electric storage mechanisms, such as batteries, to store electricity until it is needed to power the electric vehicle. The electric storage mechanisms require periodic charging to replenish the electric charge for continued operation. The electricity used to charge the electric storage mechanisms may be provided by any type of on-vehicle power generation and charging mechanism. The on-vehicle power generation and charging mechanisms may include consumptive power generation systems and/or non-consumptive power generation systems, such as, without limitation, fuel cells, gasoline powered combustion engines, bio-diesel powered engines, solar powered generators and regenerative braking systems.

In totally electric vehicles and plug-in hybrid electric vehicles, charging of the electric vehicles can also be accomplished by plugging the electric vehicle into an off-vehicle charging station. The off-vehicle charging station provides an external source of electricity, such as, an electric power grid. Totally electric vehicles require this type of off-vehicle charging in all cases. Off-vehicle charging is also likely to be significantly less expensive for plug-in hybrid electric vehicles than on-vehicle charging given currently available technology. Consequently off-vehicle charging may be the preferred charging mode for electric vehicle owners.

The power stored in the electric storage mechanisms on the electric vehicles and on-vehicle power generation mechanisms may be used to provide electricity back to the electricity grid. For electric vehicles to be used as suppliers of electric power to an electric power grid, electric vehicles are connected to an off-vehicle infrastructure which can efficiently consume the electricity generated or stored by the electric vehicle. To date, electric vehicle manufacturers and electric utility companies have only planned and provided infrastructure and methods for the most rudimentary charging scenario in which the electric vehicle is plugged into a common electric outlet.

### BRIEF SUMMARY OF THE INVENTION

According to one embodiment of the present invention, a computer implemented method, apparatus, and computer program product for managing electric vehicle charging transactions is provided. A transaction plan approval service receives an energy transaction plan and an identification of a set of principals associated with the energy transaction plan from an energy transaction planner. In response to a determination that the energy transaction plan is pre-approved by the set of principals, an energy transaction plan approval service sends a notification to the energy transaction planner indicating that the energy transaction plan is approved to form an approved energy transaction plan. In response to a determination that the energy transaction plan requires express approval from a subset of principals in the set of principals, the transaction plan approval service sends a request for approval of the energy transaction plan to each principal in the subset of principals. In response to receiving an approval from the each principal in the subset of principals, the transaction plan approval service sends the notification to the energy transaction planner indicating that the energy transaction plan is approved to form the approved energy transaction plan. The approved energy transaction plan is sent to an execution engine for implementation.

### BRIEF DESCRIPTION OF THE SEVERAL VIEWS OF THE DRAWINGS

FIG. 1 is a block diagram of a network of data processing systems in which illustrative embodiments may be implemented;

FIG. 2 is a block diagram of a data processing system in which illustrative embodiments may be implemented;

FIG. 3 is a block diagram of an energy transaction infrastructure in accordance with an illustrative embodiment;

FIG. 4 is a block diagram of a transaction plan approval service in accordance with an illustrative embodiment;

FIG. 5 is a block diagram of electric vehicle charging preferences in accordance with an illustrative embodiment;

FIG. 6 is a block diagram of preference settings in accordance with an illustrative embodiment;

FIG. 7 is a block diagram of parties to an electric vehicle charging transaction in accordance with an illustrative embodiment;

FIG. 8 is a block diagram of a set of fields in an energy transaction plan in accordance with an illustrative embodiment;

FIG. 9 is a block diagram of a set of fields in an energy transaction plan summary in accordance with an illustrative embodiment;

FIG. 10 is flowchart illustrating an energy transaction plan approval process in accordance with an illustrative embodiment;

FIG. 11 is a flowchart illustrating a process for obtaining confirmation from a principal in accordance with an illustrative embodiment; and

FIG. 12 is a flowchart illustrating a process for approving or disapproving energy transaction plans in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wired, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

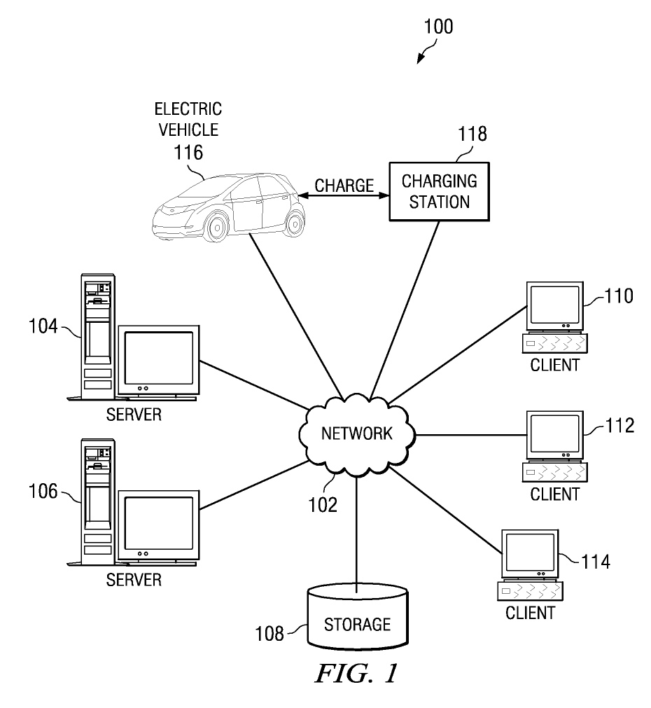

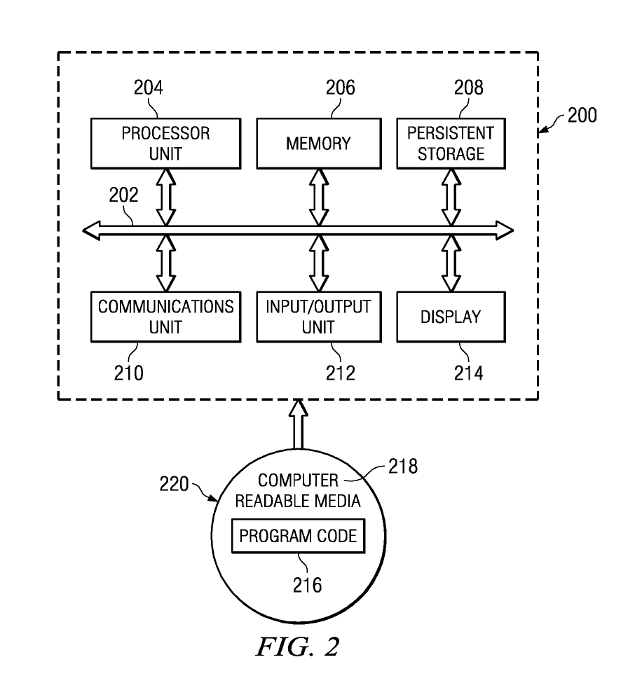

With reference now to the figures, and in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing system in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Electric vehicle 116 is any vehicle that utilizes electric power in whole or in part to drive the vehicle that is capable of being plugged into charging station 118. Electric vehicle 116 may be a totally electric vehicle or a plug-in hybrid electric vehicle. The plug-in electric hybrid vehicle may be a gasoline/electric hybrid, a natural gas/electric hybrid, a diesel/electric hybrid, a biodiesel/electric hybrid, or any other type of plug-in electric hybrid. Electric vehicle 116 may optionally include an on-vehicle power generation mechanism such as, but without limitation, solar power electric generators, gasoline powered electric generators, biodiesel powered electric generator, or any other type of on-vehicle electric power generation mechanism.

Charging station 118 is any station, kiosk, garage, power outlet, or other facility for providing electricity to electric vehicle 116. Electric vehicle 116 receives electricity from, or provides electricity to, an electric grid at charging station 118. In other words, electric charge may flow from an electric grid through charging station 118 to electric vehicle 116 or the electric charge may flow from electric vehicle 116 back into the electric grid through charging station 118. Charging station 118 is a selected charge/discharge site, such as an outlet or kiosk, for providing electric vehicle 116 with access to the electric grid. For example, and without limitation, charging station 118 may be a power outlet in a privately owned garage, an electric outlet in a docking station in a commercially owned electric vehicle charging kiosk, or a power outlet in a commercially owned garage.

Electric vehicle 116 connects to charging station 118 via an electrical outlet or other electricity transfer mechanism. The electricity may also be optionally transferred via wireless energy transfer, also referred to as wireless power transfer, in which electrical energy is transferred to a load, such as electric vehicle 116, without interconnecting wires. The electricity may flow from charging station 118 into electric vehicle to charge electric vehicle 116. The electricity may also flow from electric vehicle 116 into charging station 118 to sell electricity back to the power grid.

Electric vehicle 116 and charging station 118 are optionally connected to network 102. Electric vehicle 116 and charging station 118 send and receive data associated with the charging of electric vehicle, the capabilities of electric vehicle, the capabilities of charging station 118, the current charge stored in electric vehicle, the rate of charging electric vehicle, the price of electricity received from a power grid, identity of the owner and/or operator of electric vehicle 116 and/or any other data relevant to charging or de-charging electric vehicle 116 over network 102.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. Data processing system 200 may also be implemented as a computing device on-board an electric vehicle, such as electric vehicle 116 in FIG. 1.

In this illustrative example, data processing system 200 includes communications fabric 202, which provides communications between processor unit 204, memory 206, persistent storage 208, communications unit 210, input/output (I/O) unit 212, and display 214. Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. In another example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Currently, electric vehicle manufacturers and electric utility companies have only planned and provided infrastructure for the most rudimentary charging scenarios, such as, merely plugging the electric vehicle into a common electric outlet that is owned by the owner and operator of the electric vehicle. The illustrative embodiments recognize that charging electric vehicles will frequently be conducted under much broader and more complex sets of circumstances than this simple scenario and infrastructure is needed to accommodate these complex transactions. For example, owners and operators of electric vehicles will frequently be required to charge their electric vehicle at a charging station that is remote from the home of the electric vehicle owner. In most circumstances, it is unlikely that the electric vehicle owner will own the off-vehicle charging stations from which the owner obtains electricity to recharge the electric vehicle. In such a situation, the owner or operator of the electric vehicle will likely be required to pay for the charge obtained from the off-vehicle charging station.

The illustrative embodiments recognize that the charging transactions by which electric vehicles obtain electricity from an off-vehicle charging station to charge the electric vehicle requires a much more complete, flexible, and interoperable system governing all aspects of the charging transaction. Electric vehicle charging transactions can be divided into the pre-charge phase, the charge phase, and the post-charge phase. During the pre-charge phase of decision enablement, a charging plan is generated and all parties are presented with the conditions governing the charging transaction. During the charging phase, electricity flows to, from, or is stored in the electric vehicle. Finally, during the post-charge phase of the transaction, an analysis is performed to provide incentives and induce specific behaviors on the part of any party involved in the transaction. Additional charging infrastructure may also be provided to meter electricity at the point of charge, identify the various parties involved in the transaction, and provide flexible business rules governing the flow of funds between those parties.

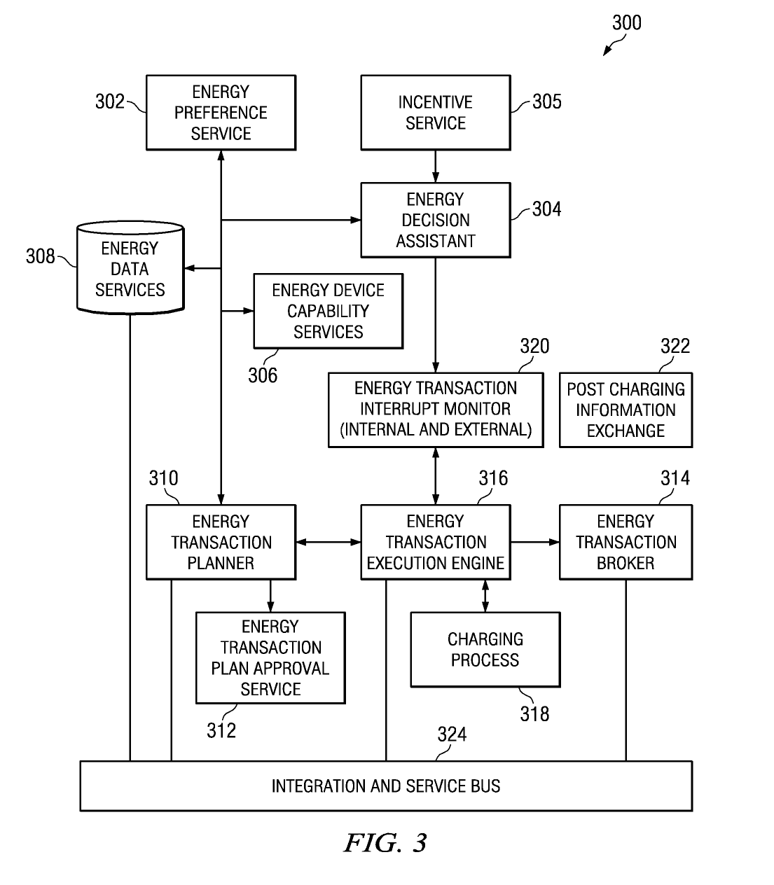

FIG. 3 is a block diagram of an energy transaction infrastructure in accordance with an illustrative embodiment. Electric vehicle energy transaction infrastructure 300 is a charging infrastructure for managing all phases of an electric vehicle charging transaction. During the pre-charge phase, all parties of the transaction are presented with the conditions governing the charging transaction. The parties may include, without limitation, the owner of the electric vehicle to be charged, the operator of the electric vehicle, the owner of the charging station, and an electric utility company providing electricity to an electric power grid associated with the charging station. Parties agree to conditions relevant to their role in the transaction prior to the charge commencing. There are likely to be many special circumstances in the terms and conditions which are presented in standard formats which are universally understood and which can be readily communicated and agreed upon by all parties.

During the pre-charge phase, electric vehicle energy transaction infrastructure 300 utilizes energy preference service 302, energy decision assistant 304, incentive service 305, energy device capability services 306, energy data services 308, energy transaction planner 310, and optionally, energy transaction plan approval service 312 to generate a plan governing the charging transaction to the parties involved in the transaction.

Energy preference service 302 is a software component that generates, stores, and retrieves preference information associated with an electric vehicle and the preference information associated with the parties to the transaction. Preferences may include, without limitation, a maximum price per kilowatt hour of electricity to be paid by a party, a location where charging may occur, a location where charging may not occur, a rate of charging the electric vehicle, a minimum amount of charge, or any other preferences associated with charging an electric vehicle. The preferences may be pre-generated by one or more of the parties to the transaction.

Energy decision assistant 304 is an optional service that provides real-time options and trade-offs for a particular trip. For example, energy decision assistant 304 may monitor available incentives, weather conditions, a travel route, traffic information, and other real-time data to identify the best electric vehicle charging options for a particular trip.

Incentive service 305 receives offers of incentives from third party vendors. The incentives may be offers of discounts, rebates, rewards, and/or other incentives associated with charging an electric vehicle to encourage an operator of the electric vehicle to perform one or more behaviors associated with charging the electric vehicle. For example, and without limitation, an incentive may offer to charge the electric vehicle for free at a particular charging station if the owner or operator of the electric vehicle purchases one or more products from the third party vendor. Incentives service 305 provides information describing current incentives to energy transaction planner 310. In one embodiment, incentives service 305 provides the information describing the incentives to energy decision assistant 304. Energy decision assistant 304 then provides the incentives information to energy transaction planner 310.

Energy device capability service 306 is a software component that identifies and validates device capabilities. For example, and without limitation, energy device capability service 306 may include information describing the charging capabilities of the charging station, the charging requirements of the electric vehicle, the maximum storage capacity of the electric vehicle on-vehicle storage mechanisms, the existing amount of charge in the electric vehicle, the number of amps of electricity the charging station is capable of providing, and any other information associated with the capabilities and requirements of the electric vehicles and the charging station.

Energy data services 308 are a set of one or more third party data sources providing information relevant to the energy transaction. Energy data services 308 may include, without limitation, weather information sources, traffic information sources, map and travel information sources, charging station price information sources, or any other third party information sources.

Energy transaction planner 310 is an application that creates a transaction plan for governing the electric vehicle charging transaction based on preferences of one or more principals. Energy transaction plan approval service 312 approves the transaction plan and validates with energy transaction broker 314. Energy transaction plan approval service 312 may be required to notify one or more parties of the terms of the transaction and obtain approval of one or more of the terms from the party. For example, and without limitation, if an operator of the electric vehicle is not the owner of the electric vehicle, energy transaction plan approval service 312 may require approval from the owner of the vehicle before allowing the vehicle to receive power at a charging station if the charging station and/or a utility will charge the owner of the electric vehicle a fee for the charging transaction. A utility refers to a provider of electric power. A utility typically provides electric power to a charging station via an electric power grid.

In this example, the charging phase begins when energy transaction execution engine 316 sends the transaction plan generated by energy transaction planner 310 for approval by energy transaction plan approval service 312, initiates the request to begin charging the electric vehicle, monitors and logs the health and safety of charging process 318, and receives requests from energy transaction interrupt monitor 320. During charging process 318, electricity flows into the electric vehicle or out of the electric vehicle and back into the power grid. Energy transaction interrupt monitor 320 monitors data transmissions to detect interrupt conditions that may terminate the flow of electric power to or from a vehicle. The interrupts may originate from the power grid, suppliers, and/or vehicles. For example, if a price of energy exceeds a predefined threshold in violation of a user-selected preference, energy transaction interrupt monitor 320 detects this interrupt condition and initiates appropriate actions to handle the cessation of electric power flow to the electric vehicle.

Energy transaction broker 314 supports settling an electric vehicle charging and discharge transaction independent of electricity supplier, parking space supplier, electrical infrastructure supplier, taxing authority, incentive provider, or other interested party. Elements include pricing schedules, time based pricing, facility recovery, tax collection, incentives, and/or fixed plans. Energy transaction broker 314 may also be used by energy transaction approval service 312 to validate the financial elements of the energy transaction plan prior to plan approval and prior to charging the electric vehicle.

The post-charge phase comprises analysis of the completed energy transaction to provide incentives, redeem credits or benefits, and induce specific behaviors by one or more parties involved in the charging transaction. The post-charge phase also includes payment of the appropriate parties for the energy transaction in accordance with the energy transaction plan governing the transaction. Various programs may be available to incent specific behaviors on the part of consumers. For example, a vehicle owner or user may receive reduced electricity rates if vehicle charging is conducted during off-peak times, such as during the night rather than during daylight hours when electricity usage is higher. Post charging information exchange 322 accumulates data pertinent to these incentives or redemption programs, authenticates the incentives data, and analyzes the incentives data to identify the most effective business process and optimize incentives for the parties.

During this charging phase, payment or fees for the charge are also recorded. Operational and financial parameters are conveyed for an optimum charge to occur. For example, a dynamic representation of an electric vehicle capability to consume charge should be understood at all times during the charging process to ensure the vehicle is not damaged or that the protections of the charging system are preserved. Electricity metering of the power flow may also be conducted and reported. Standards representing the acceptable charging voltage and amperage ranges, for example may be communicated and maintained for a safe charging transaction to occur. All data pertinent to the financial transaction is conveyed and recorded.

In one embodiment, a party that will be responsible for paying for electricity as an element of an electric vehicle charging transaction. An on-vehicle receiver maintains the data required to complete the electric vehicle charging transaction. The electric vehicle charging transaction comprises identifying at least one party paying the electric vehicle charge, the vehicle to be charged, and the relationship between the party and the electric vehicle. For example, the relationship between the party and the electric vehicle may be an owner of the electric vehicle, an operator of the electric vehicle, a renter of the electric vehicle, a utility associated with the electric vehicle, or any other relationship. Once the relationship is established, the charging of the storage mechanisms on the electric vehicle is performed.

The components shown in FIG. 3 may be implemented on a data processing system associated with an electric vehicle. In such case, the components communicate and transfer data using integration and service bus 324. Integration and service bus 324 is an internal communication system within the electric vehicle, such as any wired or wireless communications system. A wired communications system includes, without limitation, a data bus or a universal serial bus (USB). If one or more components shown in FIG. 3 are located remotely, the components may transfer data using any type of wired or wireless network connection to connect to a network, such as network 102 in FIG. 1. A wireless network connection may be implemented over a cell-phone network, satellite, two-way radio, WiFi networks, or any other type of wireless network.

Presently, current processes for charging electric vehicles involve connecting the electric vehicle directly to a conventional electrical outlet. These methods provide no mechanism for establishing and enforcing the terms surrounding the electric vehicle charging transaction. The embodiments recognize that these limited methods severely restrict the conditions under which an electric vehicle charge can occur. For example, charge/discharge outlet site owners, such as outlets at a charging station, will likely restrict access to charging station facilities if the owners are not assured of reimbursement for the electricity consumed by one or more electric vehicles. Therefore, the embodiments recognize a need for energy transaction plans to govern a plurality of aspects of an electric vehicle charging transaction. Moreover, there is a need for a mechanism to permit the parties involved in the charging transaction to provide approval for the plan prior to implementing the electric vehicle charging transaction plan. Therefore, according to one embodiment of the present invention, a computer implemented method, apparatus, and computer program product for approving electric vehicle charging transactions is provided.

In this embodiment, a transaction plan approval service receives an energy transaction plan and an identification of a set of principals associated with the energy transaction plan from an energy transaction planner. The set of principals may be a single principal, as well as two or more principals. In response to a determination that the energy transaction plan is pre-approved by the set of principals, an energy transaction plan approval service sends a notification to the energy transaction planner indicating that the energy transaction plan is approved to form an approved energy transaction plan. In response to a determination that the energy transaction plan requires express approval from a subset of principals in the set of principals, the transaction plan approval service sends a request for approval of the energy transaction plan to each principal in the subset of principals. The subset of principals may include a single principal or two or more principals. For example, the subset of principals may include only the electric vehicle operator or the electric vehicle operator and the charging station operator. The subset of principals may also include all the principals in the set of principals or only some of the principals in the set of principals.

In response to receiving an approval from the each principal in the subset of principals, the transaction plan approval service sends the notification to the energy transaction planner indicating that the energy transaction plan is approved to form the approved energy transaction plan. The approved energy transaction plan is sent to an execution engine for implementation. In response to receiving a rejection of the energy transaction plan from at least one principal in the subset of principals, the transaction plan approval service sends a notification to the energy transaction planner indicating that the energy transaction plan is rejected to form a rejected energy transaction plan. The rejected energy transaction plan is not sent to the execution engine.

In one embodiment, if the transaction plan approval service does not receive an express approval or rejection of the energy transaction plan from a principal in the subset of principals, the transaction plan approval service analyzes at least one of preferences selected by the principal, a past history, past course of conduct, and contractual relationships between the principals to determine whether the principal would have likely provided approval for the energy transaction plan. The past history and past course of conduct may include, without limitation, a record of previous approvals and rejections of energy transaction plan terms made by the principal. In response to a determination that the principal would likely have approved the energy transaction plan, the transaction plan approval service provides an implied approval of the energy transaction plan on behalf of the principal.

In another embodiment, if the energy transaction plan is a complex plan, the transaction plan approval service generates a summary of the energy transaction plan. The transaction plan approval service then sends the summary of the energy transaction plan with the request for approval of the transaction plan to the each principal in the subset of principals in addition to the complete energy transaction plan or the summary may be sent instead of the complete energy transaction plan. The energy transaction plan, the plan summary, and/or the request for approval are presented to a principal in the subset of principal on a user input/output interface on the electric vehicle. The principal may manually provide approval. In another embodiment, if the principal does not select to explicitly approve or disapprove of the plan within a specified amount of time, the plan may be automatically approved or the plan may be automatically disapproved based on predetermined settings and/or pre-selected preferences. In another embodiment, a principal may have preset automatic approval for transaction plans. In which case, the principal is not required to review the transaction plan or provide explicit approval or disapproval of the plan.

In response to identifying a principal in the subset of principals at a remote computing device, the approval service may send the energy transaction plan and the request for approval of the energy transaction plan to a remote computing device using a network interface. The remote computing device presents the energy transaction plan or the plan summary, along with the request for approval to the principal using a device associated with a user input/output device on the remote computing device. The remote computing device may display the transaction plan and the request on a display device, present the energy transaction plan and the request in an audio format using an audio device, or any other type of presentation. Thus, the approval service may obtain automated approval without displaying the energy transaction plan and/or the request or the approval service may utilize an audio device to request approval.

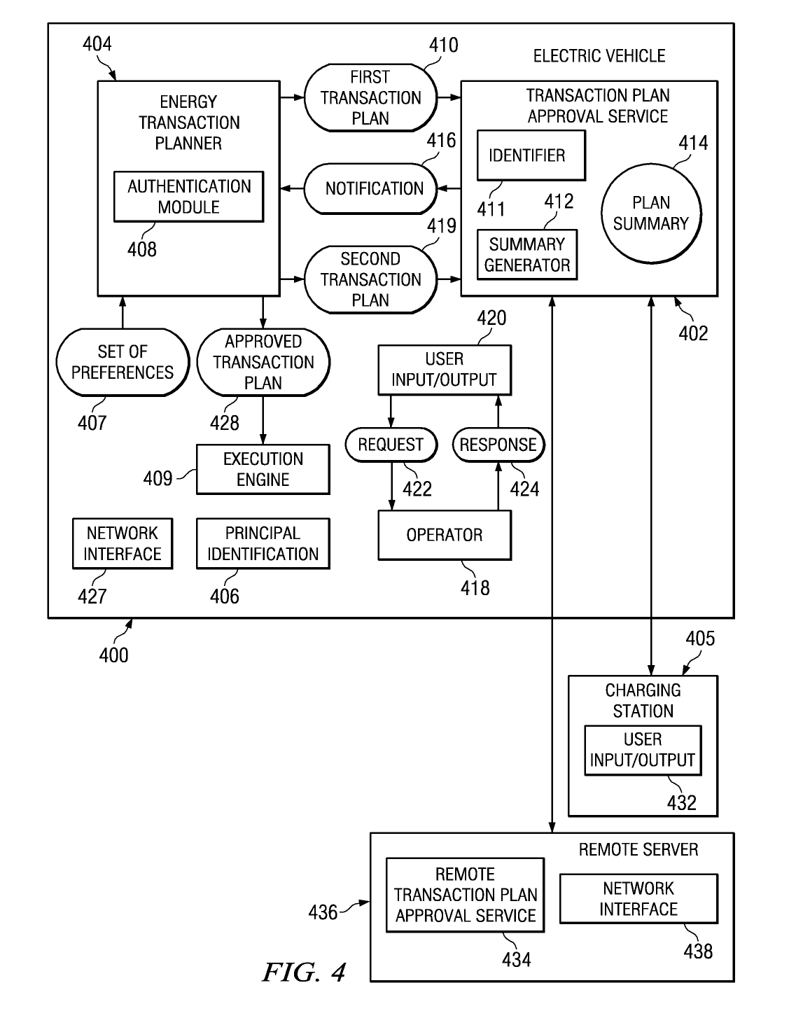

FIG. 4 is a block diagram of a transaction plan approval service in accordance with an illustrative embodiment. Electric vehicle 400 is an electric vehicle that relies in whole or in part on electricity to drive the vehicle, such as, without limitation, electric vehicle 116 in FIG. 1. Transaction plan approval service 402 is a software component that approves or disapproves energy transaction plans for implementation, such as energy transaction plan approval service 312 in FIG. 3. Energy transaction planner 404 obtains authorization or approval for a particular energy transaction plan prior to submitting the energy plan for execution. In other words, transaction plan approval service 402 determines whether a particular transaction plan generated by energy transaction planner 404 should be executed or whether the plan should be rejected.

In this example, transaction plan approval service 402 is fully functional on-board electric vehicle 400. Transaction plan approval service 402 may also optionally be embodied on a computing device that is located remotely from electric vehicle 400. Energy transaction planner 404 may also be located on electric vehicle 400 or on a remote computing device. Energy transaction planner 404 and energy transaction plan approval service 402 may be located on the same electric vehicle, the same remote computing device, or on different electric vehicles and/or different computing devices that are remote from each other. In other words, energy transaction planner 404 may be located on a remote computing device while transaction plan approval service 402 is located on electric vehicle 400, or vice versa.

Energy transaction planner 404 is a software component that creates a transaction plan for controlling a charging transaction for electric vehicle 400 coupled to charging station 405, such as energy transaction planner 310 in FIG. 3. Charging station 405 is a station, garage, kiosk or other structure associated with an electric outlet for permitting electric vehicle 400 to connect to an electric grid to charge or de-charge electric vehicle, such as charging station 118 in FIG. 1.

A charging transaction is a transaction that involves at least one of charging the electric vehicle, storing electric power in an electric storage mechanism associated with the electric vehicle, and/or de-charging the electric vehicle. De-charging refers to removing or drawing electric power from electric vehicle 400 and returning the electric power to a power grid associated with charging station 405. As used herein the phrase “at least one of” when used with a list of items means that different combinations of one or more of the items may be used and only one of each item in the list is needed.

For example, at least one of charging the electric vehicle, storing electric power in an electric storage mechanism, and de-charging the electric vehicle may include, for example and without limitation, only charging the electric vehicle or a combination of charging the electric vehicle and storing electric power in an electric storage mechanism associated with the electric vehicle. This example also may include a transaction that involves any combination of charging the electric vehicle, storing electric power in an electric storage mechanism associated with the electric vehicle, and de-charging the electric vehicle. In addition, the charging, storing, and de-charging may occur more than one time during a given charging transaction. For example, during a single transaction, the electric vehicle may be de-charged, then charged, used to store electric power in the electric storage mechanism for a given time, then de-charged for a second time, and after a given time period, the electric vehicle may be re-charged again. All these occurrences of charging, storing, and de-charging may occur in a single charging transaction or in a series of two or more charging transactions.

Energy transaction planner 404 gathers information from a variety of sources necessary for it to calculate and structure a complete energy transaction plan in preparation for an energy transfer transaction to or from electric vehicle 400 and/or to or from the electric grid at a selected charge/discharge site, such as charging station 405. Energy transaction planner 404 requests an identification of all principals associated with a charging transaction from one or more components, such as principal identification 406. Principal identification 406 is a component to identify one or more principals. A principal is any entity that may have an interest or role in the energy transaction, including but not limited to the vehicle operator, vehicle owner, charging station owner or operator, utilities associated with any or all of the other principals. The owner and operator of electric vehicle 400 may be the same person or the owner and operator of the vehicle may be different people.

Principal identification 406 may include a badge reader, a radio frequency identification tag reader, a biometric device, a prompt requesting a password and/or user login, or any other type of identification mechanism. The biometric device may include, without limitation, a fingerprint scanner, a thumbprint scanner, a palm scanner, a voice print analysis tool, a retina scanner, an iris scanner, a device for reading deoxyribonucleic acid (DNA) patterns of the user, or any other type of biometric identification device.

Likewise, the identification of the user may include, without limitation, a user name, a password, a personal identification (PIN) number, an identifier, a fingerprint, a thumbprint, a retinal scan, an iris scan, or any other type of identification. The identification is associated with the set of preferences to map the set of preferences with the identification of the user that created the set of preferences. In another embodiment, security authentication, authorization, and/or identification information for the principal's identity may also be provided. The identification of an operator of electric vehicle 400 may also be accomplished via the driver preference settings available on electric vehicle 400.

Principal identification 406 may also authenticate users that request input/access to an energy preference service to create, update, modify, delete, view, or otherwise access set of preferences 407, such as for example and without limitation, to initiate a planning phase. An energy preference service is a software component for creating, managing, storing, requesting, updating, and/or retrieving set of preferences 407 for electric vehicle 400, such as energy preference service 302 in FIG. 3. Set of preferences 407 may include preferences for a single principal, as well as preferences for two or more principals.

Energy transaction planner 404 utilizes set of preferences 407 to create a charging transaction plan to control the charging, de-charging, or storing of electric power associated with electric vehicle 400. Preferences are choices selected by one or more principals setting preferences for managing, governing, and/or controlling one or more aspects of an electric vehicle charging transaction. In other words, a preference specifies a parameter or aspect of the charging transaction that is to be minimized, maximized, or optimized. A parameter of the charging transaction is any feature of the charging transaction, such as, without limitation, a rate of charging, a length of time for charging, a time to begin charging, a time to cease charging, a maximum level of charge, a minimum level of charge, or any other aspect of the charging transaction.

It will be appreciated by one skilled in the art that the words “optimize”, “optimization” and related terms are terms of art that refer to improvements in speed, efficiency, accuracy, quality, and/or improvement of one or more parameters of electric vehicle charging transactions, and do not purport to indicate that any parameter of the charging transaction has achieved, or is capable of achieving, an “optimal” or perfectly speedy, perfectly efficient, and/or completely optimized state.

Each preference may optionally be associated with a weighting. Energy transaction planner 404 identifies the weighting associated with each preference in set of preferences 407. The weighting indicates a priority of each preference relative to other preferences in set of preferences 407. If two or more preferences in set of preferences 407 are conflicting preferences, energy transaction planner 404 uses the weighting to determine which preference is given priority. In other words, energy transaction planner 404 uses the weighting to determine the extent to which each preference will be maximized, minimized or optimized.

For example, a preference may specify that charging at charging stations that obtain power from environmentally friendly, “green”, wind farms is to be maximized while charging at charging stations that obtain power from “brown”, coal powered plants that may be harmful to the environment and should be minimized. Brown energy refers to power generated from polluting sources, as opposed to green energy that is produced from renewable or less polluting energy sources.

Preferences may also specify the price per kilowatt hour the user is willing to pay to charge the electric vehicle, identify certain charging stations the user prefers to fully charge electric vehicle 400 and identify other charging stations at which the user prefers to partially charge electric vehicle 400, perhaps due to proximity to the user's home or due to the source of the electricity used by charging station 405. For example, preferences may indicate that charging when the price per kilowatt hour is less than thirteen cents is to be maximized and charging when prices are higher than thirteen cents per kilowatt hour is to be minimized or prohibited all together. In another example, preferences may specify a limit, such as, without limitation, buy electricity up to a certain price or optimize the cost of the return trip home given the current prices of gas and electricity.

Preferences may be static, dynamic, or temporary preferences. A static preference is a preference that is effective until the user changes the preference. A static preference may be referred to as a default preference. A dynamic preference is a preference that does not have a predetermined value. A dynamic preference requires a user to enter a value for the dynamic preference in real time as the set of preferences responsive to the request of energy transaction planner 404. Thus, if a preference for the operator of the vehicle charging electric vehicle 400 is a dynamic preference, the principal is always prompted to enter a preference value indicating whether a particular operator of electric vehicle 400 is authorized to charge the electric vehicle. A user may choose to make a preference for operator charging electric vehicle 400 a dynamic preference so that the owner of electric vehicle 400 will always be informed of who is attempting to charge electric vehicle 400 and have the option of preventing the charging of electric vehicle 400 in real time prior to commencing of the charging transaction. A temporary preference is a preference that is only valid for a predetermined period of time. When the period of time expires, the temporary preference is invalid and no longer used. For example, a user may set a temporary preference that indicates no charging is to be performed for the next ten minutes at the charging station where the user is parked because the user is only going to be parked for five minutes. At the end of the ten minute time period, the temporary preference expires and electric vehicle 400 can begin charging if the electric vehicle 400 is still parked at the charging station.

Energy transaction planner 404 requests set of preferences 407 for a particular charging transaction by sending a request to an energy preference service. The energy preference service may be located on electric vehicle 400 or on a computing device located remotely from electric vehicle 400. The request includes an identification of one or more principals and the request for set of preferences 407 that are of interest to the particular charging transaction. In other words, energy transaction planner 402 does not request every preference for every known principal. Instead, energy transaction planner 404 identifies particular principals and requests specific preferences that are needed for creating a transaction plan for a particular charging transaction for those identified principals. In response to the request, the energy preference service identifies the requested preferences and retrieves those requested preferences for the identified principals to form set of preferences 407. The energy preference service sends set of preferences 407 to energy transaction planner 404. Set of preferences 407 includes a subset of preferences for each principal identified by energy transaction planner 404.

Set of preferences 407 may be sent to energy transaction planner 404 over a universal serial bus (USB) or other wired or wireless connection within electric vehicle. Set of preferences 407 may also be transferred to energy transaction planner 404 from a remote energy preference service that is not located on electric vehicle 400. In other words, the energy preference service may be located on a mobile computer, such as a personal digital assistant (PDA), cellular telephone, or laptop computer. The energy preference service may also be located on a remote energy preference server or on a remote client computer. In such cases, set of preferences 407 may be sent to energy transaction planner 404 by the remote energy preference service using a wired or wireless network connection. For example, energy transaction planner 404 may receive set of preferences 407 from a remote energy preference service on a mobile personal digital assistant (PDA), a third set of preferences from a remote energy preference service on a remote server, and a fourth set of preferences retrieved from a removable data storage device. A principal may create preferences using a user input/output device associated with the computing device hosting the energy preference service. In one embodiment, the principal may use an input/output device located on-board the electric vehicle to create the preferences. In another embodiment, the preferences may be created using a user input/output device associated with a remote computing device.

Authentication module 408 comprises any type of known or available encryption technology and/or security protocols. Authentication module 408 authenticates and/or encrypts communications between energy transaction planner 404 and transaction plan approval service 402. Authentication module 408 may be used to authenticate transaction plan approval service 402 itself or authenticate tokens provided by transaction plan approval service 402. Authentication module 408 may also be used to identify and authenticate information received from principals, charging station 405, or any other computing device.

Energy transaction planner 404 may need to have a generated transaction plan approved by energy transaction plan approval service 402 before forwarding the transition plan to execution engine 409. Execution engine 409 is a component for implementing a transaction plan, such as energy transaction execution engine 316 in FIG. 3. Energy transaction planner 404 generates first transaction plan 410 and sends first transaction plan 410 to transaction plan approval service 402 for approval or disapproval by transaction plan approval service 402. Transaction plan approval service 402 may require no input from any principal to determine if the transaction plan will be approved or disapproved. This may be the case where there are sufficient contractual relationships between the principals in the electric vehicle charging transaction. For example, when the owner of electric vehicle 400 attaches electric vehicle 400 to the electric grid at the owner's home, there may be sufficient contractual relationships between the owner of the home and the electric utility associated with the home so that the electric vehicle charging transaction that involves plugging electric vehicle 400 into an outlet in the home may be approved by transaction plan approval service 402 without obtaining confirmation or approval from any of the principals involved in the charging transaction.

For example, all principals in the set of principals associated with the energy transaction may have established contracts which pre-approve transaction plans subject to certain terms and/or conditions. The terms are part of set of preferences 407 and other input provided to energy transaction planner 404. Energy transaction planner 404 submits the proposed transaction plan to transaction plan approval service 402 along with the guarantee that all the terms and pre-conditions are met to allow approval of the transaction plan without obtaining confirmation from any of the principals. Transaction plan approval service 402 may accept the guarantee and provide immediate approval of the proposed transaction plan to energy transaction planner 404 without requiring any additional input from the principals.

In another embodiment, energy transaction planner 404 may require confirmation or approval from a set of principals. The requirements of confirmation or approval may be explicitly indicated in set of preferences 407 or by other means. For example, if set of preferences 407 does not explicitly require confirmation, confirmation may be implicitly required by the absence of a preference indicating that confirmation is not required. Express confirmation may also be required in instances where set of preferences 407 cannot be obtained or are unavailable for one or more principals.

In such a case, transaction plan approval service 402 presents the proposed energy transaction plan to each principal in the set of principals that needs to provide confirmation or approval. The set of principals may be a single principal or two or more principals. For example, the set of principals may include only operator 418 of electric vehicle 400 or operator 418 and the operator of charging station 405. Transaction plan approval service 402 presents the transaction plan via user input/output 420. Transaction plan approval service 402 requests input from each principal in the set of principals indicating approval or rejection of the transaction plan. Transaction plan approval service 402 obtains input from all principals prior to sending approval for the plan to energy transaction planner 404. The input may include an approval and/or confirmation of one or more terms of the energy transaction plan. The set of principals may include one or more principals associated with electric vehicle 400, charging station 405, or one or more remote computing devices. The one or more principals associated with electric vehicle 400 may be operator 418 of electric vehicle 400 or any other principal having access to electric vehicle 400.

Thus, in the embodiment, energy transaction planner 404 submits a proposed first transaction plan 410 to transaction plan approval service 402 for approval. Identifier 411 identifies transaction plan approval service 402 to energy transaction planner 404 and/or any other computing device which transaction plan approval service 402 attempts to establish a communication connection. In other words, transaction plan approval service 402 uses identifier 411 to identify itself. Identifier 411 may be, without limitation, a vehicle identification number (VIN) or the owner's principal identification information.

If input from a set of principal is required, transaction plan approval service 402 makes a determination as to whether first transaction plan 410 is too complex. The transaction plan may be complex if, without limitation, the plan involves a complex sequence of charge, discharge, and store events. If first transaction plan 410 is complex, transaction plan approval service 402 uses summary generator 412 to generate plan summary 414 summarizing the contents of first transaction plan 410 to simplify the presentation of the transaction plan to the set of principals. Summary generator 412 is a software component that analyzes an energy transaction plan, identifies the net results of executing the plan, and generates plan summary 414 detailing the expected results of executing the transaction plan. The summary may take many forms. For example, and without limitation, the summary may include only the net results of the charging transaction, such as the net financial gains, the net carbon emissions, the net financial losses, the final amount of charge stored on the electric energy storage mechanisms associated with electric vehicle, the total amount of time spent charging and de-charging, or any other summarized or simplified information.

Transaction plan approval service 402 submits first transaction plan 410 and/or plan summary 414 with a request for approval or confirmation of the terms of the plan to each principal in the set of principals. Transaction plan approval service 402 receives a response from each principal and makes a determination as to whether to approve or reject first transaction plan 410.

Transaction plan approval service 402 sends notification 416 to energy transaction planner 404 indicating whether first transaction plan 410 is rejected or accepted. If first transaction plan 410 is accepted, transaction planner 404 sends first transaction plan 410 to execution engine 409 for implementation. If notification 416 indicates that transaction plan approval service 402 rejects first transaction plan 410, energy transaction planner 404 may generate second transaction plan 419 to transaction plan approval service 402. In this manner, energy transaction planner 404 may continue generating new transaction plans and submitting them to transaction plan approval service 402 until a transaction plan is approved.

If a principal is associated with electric vehicle, proposed energy transaction plan or a summary of the plan along with the request for input may be displayed using user input/output 420 located on electric vehicle 400. User input/output 420 may be implemented in any type of user interface for receiving user input and providing output to the user, such as, without limitation, a graphical user interface, a command line interface, a menu driven interface, a keyboard, a mouse, a touch screen, a voice-recognition system, or any other type of input/output device. User input/output 420 may be used to receive input from operator 418, as well as a principal located at or near charging station 405. In this example, principal identification 406 receives an identification of the principal associated with charging station 405 through user input/output 420. The identification may include, without limitation, a user password/user identifier, a person identification number, a radio frequency identification (RFID) signal, or any other type of identification mechanism for verifying an identity of a principal.

The identification of the principal may be implicit in the establishment of an active electrical connection between electric vehicle 400 and charging station 405. The identification of the principal may also be explicit by some action taken by an owner or operator of charging station 405, such as, without limitation, entering a special code at an external user interface associated with charging station 405. In an alternative embodiment, transaction plan approval service 402 presents the proposed transaction plan and the request for approval to the principal associated with charging station 405 using an external user interface device managed by an owner or operator of charging station 405. The connection between transaction plan approval service 402 and this external user interface device may be via any standard wireless connection or through a wired connection. The wired connection may be established through the power charge/discharge connection or through a separate connection running in parallel. A communication protocol between transaction plan approval service 402 and the external user interface device may also be used. The communication protocol may be any type of protocol for enabling communication.

If explicit approval is required from one or more principals associated with electric vehicle 400, such as operator 418, transaction plan approval service 402 uses user input/output 420 to send the transaction plan and request 422 to the principal. User input/output 420 presents transaction plan and/or a plan summary, and request 422 to one or more principals, such as operator 418. the transaction plan, plan summary, and/or request 422 may be presented in a visual format, such as on a display screen, in an audio format, in a combination of visual and audio, in a raised, textured format, such as Braille, or in any other format. In response, operator 418 or any other principal associated with electric vehicle 400, sends response 424 to transaction plan approval service 402 indicating whether the principal approves or disapproves of the proposed transaction plan. If one or more principals in the set of principals are associated with charging station 405, transaction plan approval service 402 sends the proposed transaction plan and the request for approval or disapproval of the plan to the one or more principals associated with charging station 405 using user input/output 432. Likewise, if the set of principals includes one or more principals associated with one or more remote computing devices, transaction plan approval service 402 sends a copy of the proposed transaction plan and the request to each of the one or more remote computing devices for display to the one or more principals.

Transaction plan approval service 402 utilizes a network connection created by network interface 427 to communicate with principals associated with remote computing devices and/or principals associated with charging station 405. Network interface 427 is any type of network access software known or available for allowing electric vehicle 400 to access a network. Network interface 427 connects to a network connection, such as network 102 in FIG. 1. The network connection permits access to any type of network, such as a local area network (LAN), a wide area network (WAN), or the Internet. Electric vehicle 400 utilizes network interface 427 to connect to remote computing devices, such as remote servers and/or client computing devices.

Network interface 427 may include a protocol to securely transmit the proposed energy transaction plan and an identification of the set of principals to a utility company. The communication exchange may also include secure identification of the utility company. For example, the identification may be provided through any well known means such as public/private keys or digital signatures. The communication medium between on-board transaction plan approval service 402 and a principal, such as the utility company, may be conducted via any standard wired or wireless communication method. A wired connection may be provided through the power charge/discharge connection or in a separate connection running between electric vehicle 400 and charging station 405. Transaction plan approval service 402 may also establish a connection with a computing device associated with charging station 405 when the electrical connection is established between charging station 405 and electric vehicle 400.

Thus, transaction plan approval service 402 determines whether a proposed transaction plan is approved or disapproved based on predetermined relationships between the principals and/or express approval or disapproval of the proposed transaction plan by one or more principals associated with the electric vehicle charging transaction. Transaction plan approval service 402 informs energy transaction planner 404 as to whether the proposed plan has been approved or disapproved. If the plan is approved to form approved transaction plan 428, energy transaction planner 404 sends approved transaction plan 428 to execution engine 409 for utilization in controlling the aspects of the electric vehicle charging transaction. If the plan is disapproved, energy transaction planner 404 may create and submit a new energy transaction plan to transaction plan approval service 402 for approval. This process of receiving a rejection and creating a new plan may continue until energy transaction planner 404 receives an approval of a proposed transaction plan.

In this embodiment, transaction plan approval service 402 is located on-board electric vehicle 400. However, in another embodiment, the transaction plan approval service may be located on a computing device that is located remotely from electric vehicle, such as a laptop computer, a desktop computer, a personal digital assistant (PDA), or any other type of remote computing device. In this example, electric vehicle 400 may not include a transaction plan approval service of any type on-board electric vehicle 400. In other words, energy transaction planner 404 transmits a proposed transaction plan to the remote energy transaction plan approval service. The remote energy transaction plan approval service determines whether approval of one or more principals is required. If input from one or more principals is required, the remote energy transaction plan approval service sends the proposed energy transaction plan and a request for approval to the one or more principals. Once a determination has been made as to whether the proposed transaction plan is approved or disapproved, the remote energy transaction plan approval service transmits a notification indicating whether the plan is approved or disapproved to energy transaction planner 404. Thus, in this example, energy transaction planner 404 communicates directly with the remote energy transaction plan approval service.

In yet another embodiment, transaction plan approval service 402 may need approval from a number of different principals at a number of different locations. To facilitate obtaining approval from all of these principals, transaction plan approval service 402 may engage in a client/server relationship with a remote approval service, such as remote transaction plan approval service 434 located on remote server 436 to obtain input from one or more remote principals in the set of principals. Remote server 436 may optionally be provided as a function of an energy transaction broker, such as energy transaction broker 314 in FIG. 3. In such a case, transaction plan approval service 402 is a proxy between energy transaction planner 404 and remote transaction plan approval service 434. Energy transaction planner 404 sends a proposed transaction plan to transaction plan approval service 402. Transaction plan approval service 402 then sends the transaction plan and a request for approval or disapproval of the plan to remote transaction plan approval service 434 over any standard communication method, such as, without limitation, a wired or wireless communication network. Remote transaction plan approval service 434 obtains any necessary input from the set of principals and sends a notification indicating whether the transaction plan is approved or disapproved back to transaction plan approval service 402. Transaction plan approval service 402 then forwards the notification on to energy transaction planner. In this example, energy transaction planner 402 does not communicate directly with remote transaction plan approval service 434. Remote server 436 may also include network interface 438 to permit remote computing device to connect to electric vehicle 400 and/or one or more other remote servers and/or clients.

In still another embodiment, transaction plan approval service 402 may only request input from one or more principals in the set of principals from remote transaction plan approval service 434. In this embodiment, remote transaction plan approval service 434 does not make a final determination as to whether the transaction plan is approved or not approved. Instead, remote transaction plan approval service 434 only sends the transaction plan and a request for input to the one or more principals. When remote transaction plan approval service 434 receives a response from the one or more principals, remote transaction plan approval service 434 forwards those responses to transaction plan approval service 402 on-board electric vehicle 400 for utilization in determining whether they approve of the proposed transaction plan or reject the proposed transaction plan.

Remote transaction plan approval service 434 provides an approval service on behalf of multiple principals and reduces the communication costs to the on-board transaction plan approval service 402. Remote transaction plan approval service 434 may register some or all of the principals involved in the charging transaction, have access to the contracts and other defining relationships between the principals, and/or provide approval or rejection of a transaction plan on behalf of one or more principals on the basis of this information without actually obtaining a response from the one or more principals in real time as the transaction plan approval process is being done. Alternatively, remote transaction plan approval service 434 may obtain real-time approval from one or more of the principals, acting as an intermediary or broker for the on-board transaction plan approval service 402 as a proxy.

In another embodiment, transaction plan approval service 402 may be located on a mobile computing device, such as a personal digital assistant or a smart phone in the possession of operator 418 in electric vehicle 400. In this example, the mobile computer may have wired or wireless connectivity to the other components on electric vehicle 400. A wired connectivity may be implemented using any wired communication, such as, without limitation, a universal serial bus (USB). A wireless connectivity may be, without limitation, Bluetooth.

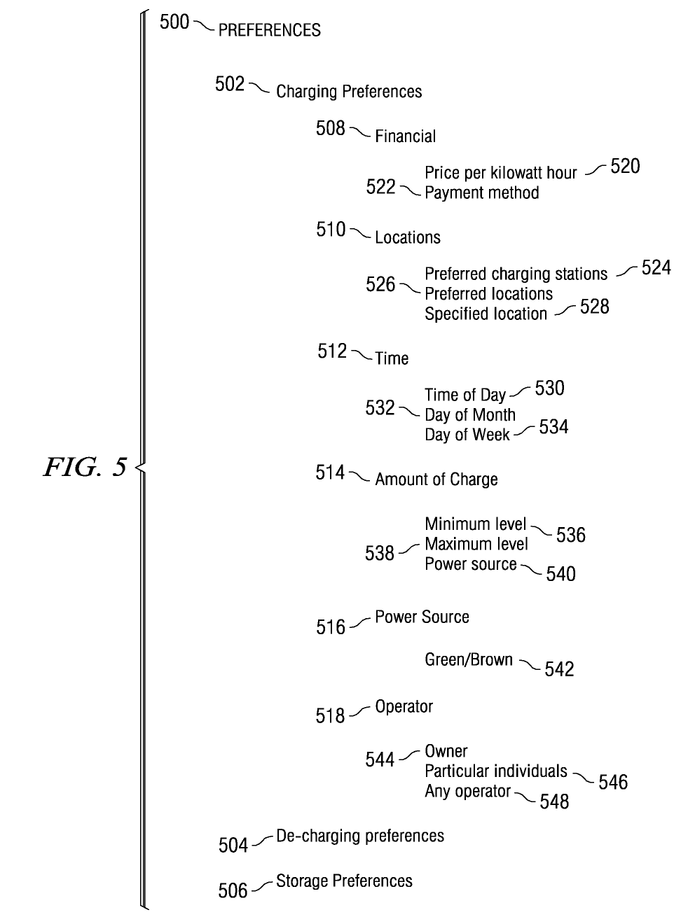

Referring to FIG. 5, a block diagram of electric vehicle charging preferences is shown in accordance with an illustrative embodiment. Preferences 500 are types of preferences that may be included within preferences for one or more users, such as set of preferences 407 in FIG. 4. Preferences 500 may be charging preferences 502 for governing energy transaction to charge an energy storage device associated with the electric vehicle, de-charging preferences 504 for governing energy transactions for de-charging or depleting the energy stored in an energy storage device, or storage preferences 506 for governing the storage of electricity in the electric vehicle's energy storage mechanisms.

A user may wish to de-charge or transfer power from the electric vehicle to a charging station if the price of the electricity is higher than when the electricity was purchased and stored in the electric vehicle. For example, if a user charges an electric vehicle at night when the price of the electricity is only nine cents per kilowatt hour, the user may wish to de-charge or provide electricity from the electric vehicle back to the charging station at noon when the price per kilowatt hour is fifteen cents because the user is able to make a profit from storing the electricity in the electric vehicle until the price of electricity increases and then selling the electricity back to the electric grid.

Some examples of charging preferences include, without limitation, financial 508, locations 510, time 512, amount of charge 514, power source 516, and/or operator 518. For example, financial 508 preferences may specify price per kilowatt hour 520 that the user is willing to pay to charge the electric vehicle or payment method 522 for purchasing the electricity from the charging station and/or the electricity grid. Payment method 522 may include, without limitation, credit cards, cash, debit card, credit, or any other type of payment. The payment type preferences may even specify a particular credit card or bank account for debit to pay for the charging transaction.

Locations 510 preferences may specify preferred charging station 524, preferred locations 526 of the charging stations, and/or specified locations 528 for charging. For example, the user may specify that any time the electric vehicle is parked at a charging station that is at a specified location, the electric vehicle is not to be charged at all, to be charged to a particular charge level, or to be fully charged. The user may wish to set these preferences because the charging stations are a given distance from the user's home or workplace, due to past service received at the charging station, or any other factors.

Time 512 preferences may specify, without limitation, time of day 530 for charging the vehicle, time of day to stop charging the vehicle, day of month 532 for charging, and/or day of the week 534 for charging the electric vehicle.

Amount of charge 514 preferences may specify minimum level 536 of charge in the electric vehicle's storage device, a maximum level of charge 538, or specify different levels of charge depending on power source 540 of the electricity used to charge the electric vehicle. If the power source is a “green” source, such as solar power, the user may specify a higher charge level than if the power source is a more environmentally harmful, or “brown” power source, such as coal or oil.

Power source 516 preferences specify types of power sources that are acceptable or preferred and/or provide weightings for different power sources. The power sources may be identified as “green” or “brown” 542. The power sources may also be identified specifically by the type of power source, such as wind, solar, coal, oil, and so forth.

Operator 518 preferences are preferences for allowing particular operators to charge the electric vehicle. Owner 544 is a preference that permits an owner to charge, particular individuals 546 permits identified individuals to charge the vehicle, and any operator 548 is a preference that permits anyone to charge the electric vehicle. The operator 518 preference may permit a user to prevent or impede theft of the electric vehicle. For example, if a user sets owner 544 as a mandatory preference that only permits the owner to charge the electric vehicle, a thief would not be permitted to recharge the electric vehicle. Therefore, a thief may not be able to transport the electric vehicle very far from the location at which the electric vehicle was stolen.

The preferences described for charging preferences 502 are only examples of some preferences that may be used. A vehicle preference service is not required to utilize all of the preferences shown in FIG. 5. Moreover, a vehicle preference service may utilize other preferences not shown in FIG. 5 without departing from the scope of the embodiments. Finally, the preferences shown for charging preferences 502 may also be used as preferences for de-charging preferences 504 and/or storage preferences 506, in addition to other preferences not shown. For example, de-charging preferences 504 may include operator 518 preferences specifying operators that are permitted to de-charge or sell power back to the electric grid, financial 508 specifying prices at which the electricity may be transferred from the electric vehicle and sold back to the electric grid, time 512 when de-charging may occur, amount of charge 514 levels for de-charging, and power source 516 of the power that is de-charged.

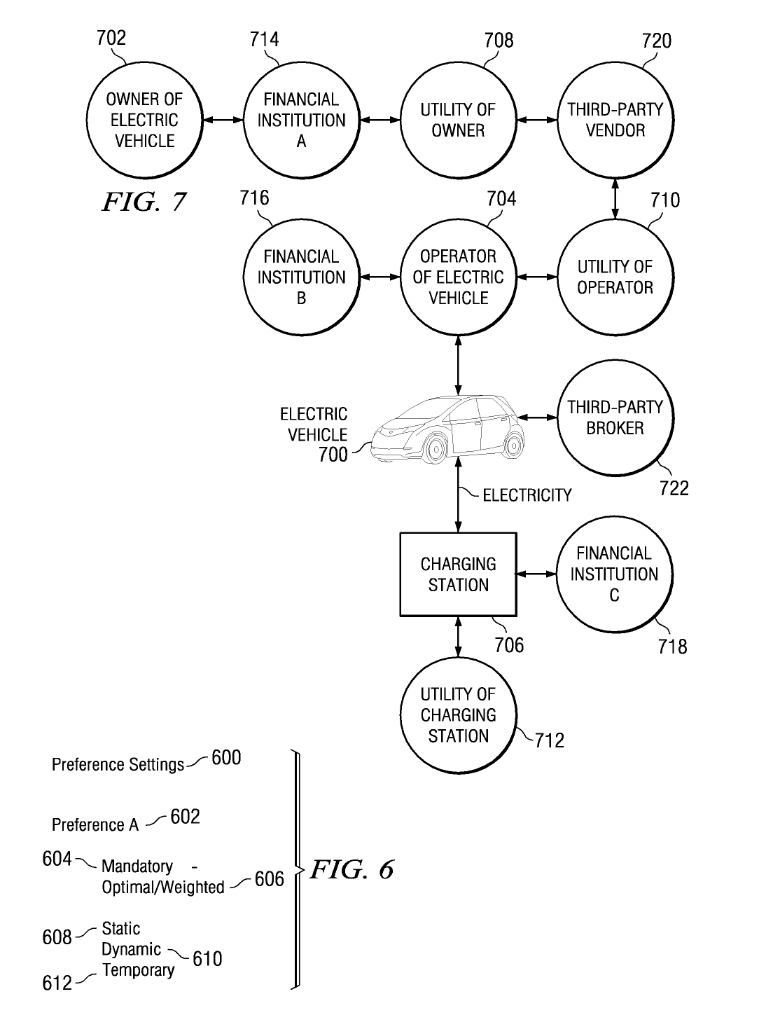

FIG. 6 is a block diagram of preference settings in accordance with an illustrative embodiment. Preference settings 600 are settings that may be appended to a preference, such as preference A 602. Preference A 602 may be any type of preference, such as, without limitation, financial, locations, time, amount of charge, power source, operator, or any other preferences. Mandatory 604 specifies that the requirements of a particular preference must be met or a charging transaction will not be permitted. For example, if a user sets an operator preference indicating that only the owner is permitted to charge the electric vehicle and the user sets the preference to mandatory, only the owner will be permitted to initiate charging of the electric vehicle. Any other operator of the electric vehicle will not be permitted to charge the electric vehicle unless the owner changes the preference settings.

Optional/weighted 606 is a setting that indicates that a preference is preferred or desirable, but not mandatory. For example, the user may specify that “green” power sources, such as wind and solar power sources, are preferred but not mandatory. In such cases, the energy transaction planner may still permit charging of the electric vehicle at charging stations that utilize electricity provided by coal powered electric generators. The weighting permits a user to indicate how strongly the user wants a particular preference to be minimized, maximized, or optimized. In the example above, the user may indicate a high weighting in favor of wind and solar power, a medium weighting for nuclear power plants, and a low weighting for coal power plants. The energy transaction planner may then use the weighting to determine how much to charge or de-charge the electric vehicle or whether to charge or de-charge the electric vehicle at all.

Static 608 indicates that a preference is a default preference that should be used in all cases. A static preference does not change from one charging transaction to the next charging transaction. Dynamic 610 setting indicates that a user wants to provide or select a value or choice for this preference every time a charging transaction plan is generated. A dynamic preference is selected in real time as the charging transaction is commencing. Temporary 612 indicates that a temporary preference value is to be used in place of a static preference for a limited period of time. For example, a user may wish to override a static preference that the electric vehicle should always be fully charged at a particular charging station with a temporary preference indicating that the electric vehicle is not to be charged because the user will only be parked at the charging station for a few minutes.

Turning now to FIG. 7, a block diagram of parties to an electric vehicle charging transaction is depicted in accordance with an illustrative embodiment. Each party may have a set of preferences for charging the electric vehicle that is managed by the vehicle preference service. A principal is any entity that may have an interest or role in the energy transaction for charging an electric vehicle, including but not limited to, the vehicle operator, owner of the electric vehicle, the owner of the charging station, the operator of the charging station, financial institutions associated with one or more of the parties, utilities associated with one or more of the principals, or third parties having an interest in the charging transaction. FIG. 7 illustrates the different relationships between principals. Any one or more of the principals shown in FIG. 7 may have preferences stored in the on-vehicle preference service.

Electric vehicle 700 is a vehicle that relies in whole or in part on electric power to drive the vehicle, such as electric vehicle 118 in FIG. 1 or electric vehicle 400 in FIG. 4. Owner of electric vehicle 702 is a principal that creates a set of preferences in vehicle preference service on electric vehicle 700. Operator of electric vehicle 704 is a principal that may be the owner or only someone that has borrowed electric vehicle 700. Each operator may optionally create their own set of preferences in the vehicle preference service on electric vehicle. Charging station 706 is a station or kiosk at which electric vehicle obtains charge or de-charges to provide electricity back to the electric grid, such as charging station 118 in FIG. 1 or charging station 434 in FIG. 4. Charging station 706 may also have a set of preferences for governing the charging of electric vehicle 700.

Each party may have a utility associated with the party. Each utility may also have preferences for governing the charging transaction. For example, utility of owner 708, utility of operator 710, and utility of charging station 712 may each be parties with an interest in the charging transaction and preferences for governing the charging of electric vehicle 700.

Each party may also have a financial institution for paying for the electricity purchased, or for being reimbursed for electricity provided back to the electric grid. A financial institution may be a bank, a credit card company, a broker, a lender, or any other financial institution. For example, financial institution A 714 may be associated with owner of electric vehicle 702, financial institution B 716 may be associated with operator of electric vehicle 704, and financial institution C 718 may be associated with charging station 706. Each of these financial institutions may have preferences for controlling how amounts due are received, how charges of payments are received and accepted, how credits are issued and received, and other aspects of financial transactions associated with charging electric vehicle 700.

Third party vendor 720 is a third party that is not associated with charging station 706 or electric vehicle 700. For example, and without limitation, third party vendor 720 may be a grocery store, a convenience store, a car wash, a repair shop, or any other type of vendor. Third party broker 722 is a third party that may provide financing or manage financial transactions associated with charging electric vehicle 700.

Each of the parties shown in FIG. 7 may optionally have preferences, constraints, limitations, or requirements associated with charging electric vehicle 700. The vehicle preference service on electric vehicle 700 may optionally store, manage, and retrieve some or all of these preferences, constraints, limitations, and requirements in data storage device on electric vehicle 700. The vehicle preference service retrieves the information of interest that is responsive to a request by an energy transaction planner and sends the preferences of interest to the energy transaction planner for use in generating a plan to govern the charging of electric vehicle 700 at charging station 706.

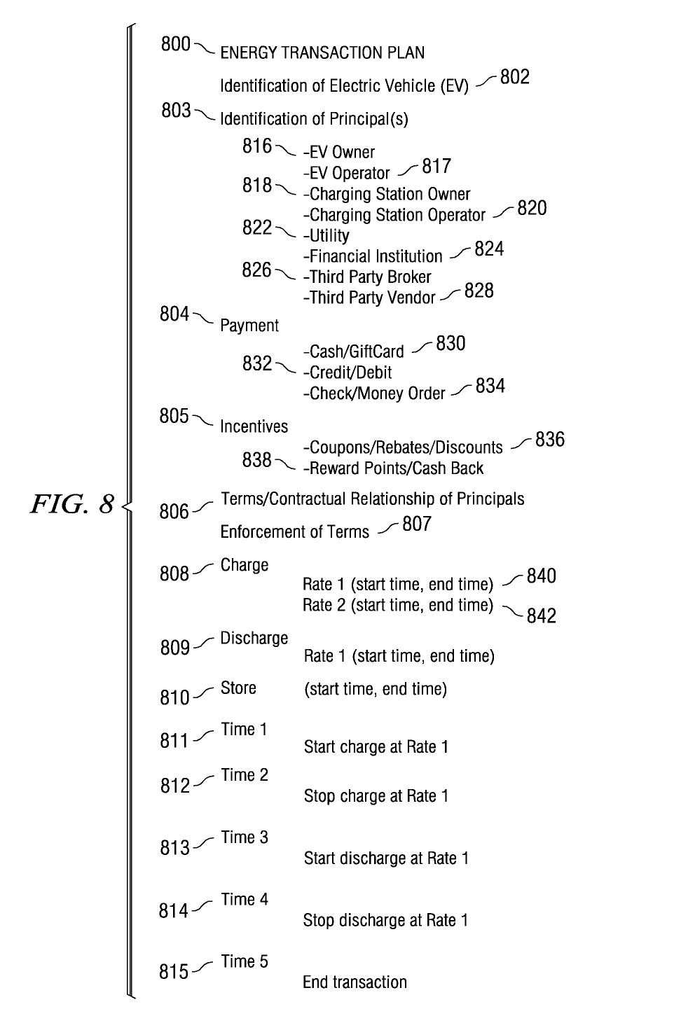

FIG. 8 is a block diagram of a set of fields in an energy transaction plan in accordance with an illustrative embodiment. Energy transaction plan 800 is a plan for managing an electric vehicle charging transaction, such as energy transaction plan 424 in FIG. 4. Energy transaction plan 800 defines an energy transfer transaction encompassing the charge, discharge, and storage of electric energy in an electric vehicle and the incumbent financial exchanges related to those energy exchanges and storage of electric power in the electric vehicle. Energy transaction plan 800 may include, without limitation, identification of electric vehicle 802; identification of principal(s) 803; payment 804 terms; incentives 805; terms/contractual relationship of the principals 806; enforcement of terms 807; charge 808, discharge 809, store 810, and/or a series of time fields indicating the electric flow direction at each time mark, such as, without limitation, time 1 811, time 2 812, time 3 813, time 4 814, and/or time 5 815.

Identification of principal(s) 803 identifies one or more principals for a particular charging transaction, such as, without limitation, electric vehicle (EV) owner 816; electric vehicle operator 817; charging station owner 818; charging station operator 820; utility 822 of the owner; operator; or charging station; financial institution 824 of the owner; operator; or utility; third party broker 826; and/or a third party vendor 828. Payment 804 may specify the type of payment method, such as, without limitation, cash/gift card 830; credit/debit 832; and/or check/money order 834. Incentives 805 are terms in energy transaction plan 800 associated with coupons/rebates/discounts 836, and/or reward points/cash back 838, or any other rewards, discounts, rebates, coupons, or other benefits.

Charge 808 orders the flow direction of electricity from the charging station into the electric vehicle during one or more specified time intervals. Rate 1 840 is a first time interval during which the electric vehicle receives electricity from the charging station at a specified rate of electricity flow. Rate 2 842 is a second time interval during which the electric vehicle receive electricity from the charging station at a specified rate. Discharge 809 indicates each time interval during which electricity flows out of the electric vehicle and back into the electric grid through the charging station. Store 810 indicates time intervals during which electricity is neither flowing into the electric vehicle nor flowing out of the electric vehicle's electricity storage mechanisms. In other words, during the one or more time intervals indicated in store 810, the electric vehicle stores electricity in the electric vehicle's storage mechanisms without charging or discharging power.

The time intervals 811-815 optionally indicate start and end times for charging, discharging, and/or storing. Energy transaction plan 800 may have multiple charge, discharge or store time windows. In this example, and without limitation, time 1 811 starts charging the electric vehicle at a given rate of electricity flow until time 2 812. At time 2 812, charging stops. At time 3 813, the electric vehicle begins discharging power back to the electric grid and continues discharging electricity until time 4 814. Time 5 815 indicates a time when the electric vehicle charging transaction ends. However, the embodiments are not limited to this example. The field for time 1 811 may have been an entry for discharging the electric vehicle instead of charging. The field for time 4 814 may be a field for storing electric power.

The time intervals may be any standard clock time, such as Greenwich Mean Time, Central Time, Pacific Time, an internal clock time for the electric vehicle, or any other standard clock time. In another embodiment, the time may be a time relative to beginning the electric vehicle charging transaction. For example, instead charge 808 stating that charging begins at 2:24 p.m. and ends at 4:24 p.m., charge 808 may state that charging begins when the charging transaction begins and ends two hours later, regardless of what time it may be.

Energy transaction plan 800 is not required to include every field shown in FIG. 8. For example, and without limitation, energy transaction plan 800 may include fields for charge 808, discharge 809, and store 810 but omit fields for time entries, such as time 1 to time 5 811-815. In addition, energy transaction plan 800 may include additional fields not shown in FIG. 8. For example, energy transaction plan may include a time 5 to begin storing electricity, time 6 to stop storing, time 7 to charge, time 8 to stop charging, time 9 to discharge, time 10 to stop discharging, and time 11 to end the transaction. In other words, energy transaction plan 800 may include any number of fields and any combination of fields to provide terms for charging, discharging, and/or storing electricity in an electric vehicle.

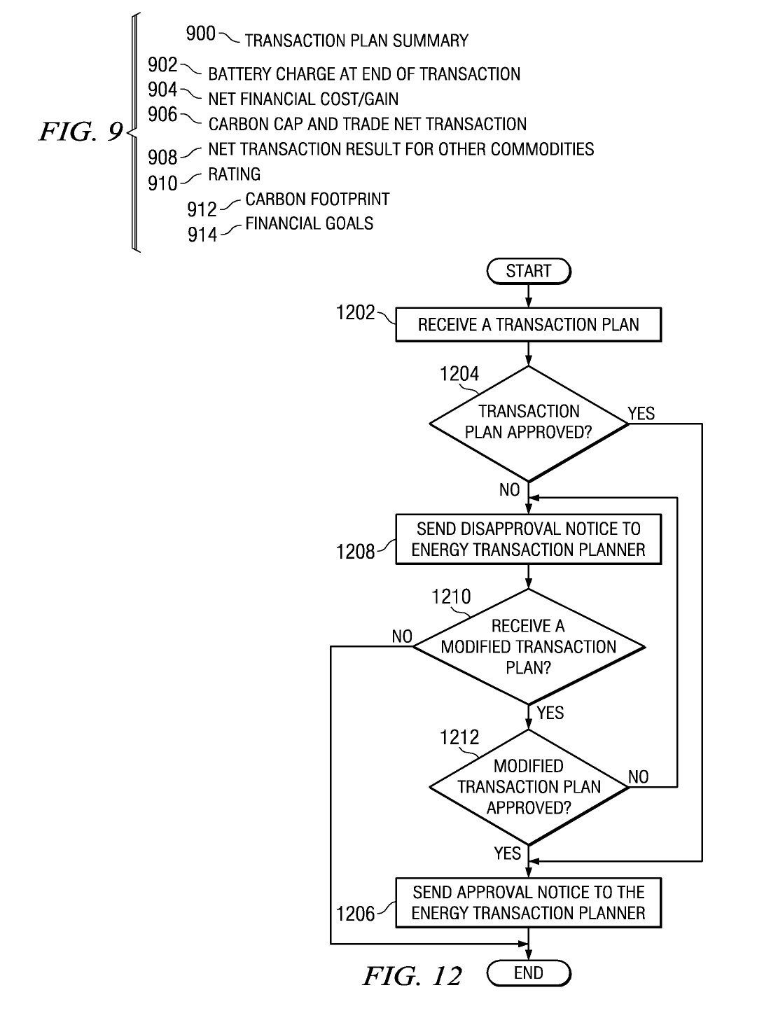

FIG. 9 is a block diagram of a set of fields in an energy transaction plan summary in accordance with an illustrative embodiment. Transaction plan summary 900 is an example of fields that may be provided in a summary of a proposed energy transaction plan generated by an energy transaction plan approval service, such as plan summary 414 in FIG. 4. Battery charge at end of transaction 902 is a field that summarizes the anticipated amount of charge in one or more electric power storage mechanisms on-board an electric vehicle at the end of an electric vehicle charging transaction. Net financial cost/gain 904 is a field that provides an anticipated net cost for electric power or an anticipated net financial gain at the end of the electric vehicle charging transaction. A net financial gain may occur where the electric vehicle purchases electricity for storage on the electric vehicle when rates for electricity are low and then sells the electricity back to the power grid during peak electric power utilization when the price of electricity is higher.

A carbon cap and trade system is a system in which those who produce carbon emissions below a certain level obtain carbon credits that may then be sold to those who produce carbon emissions above that level. Carbon cap and trade net transaction 906 is a field indicating the amount of carbon credits that may have been earned. Net transaction result for other commodities 908 is a field for indicating net gains or losses associated with other commodities. For example, net transaction result for other commodities 908 may indicate a number of reward points earned by the user, discounts on other commodities such as car wash, oil change, or other vehicle maintenance privileges, reduction of parking fees, or other commodities. Rating 910 indicates a rating for certain goals of a user. For example, carbon footprint 912 rating indicates how well the electric vehicle's carbon emissions rate on a carbon footprint scale. Financial goals 914 indicates a rating for how the actual financial costs/gains of the electric vehicle charging transaction(s) rate in accordance with the user's selected preferences.

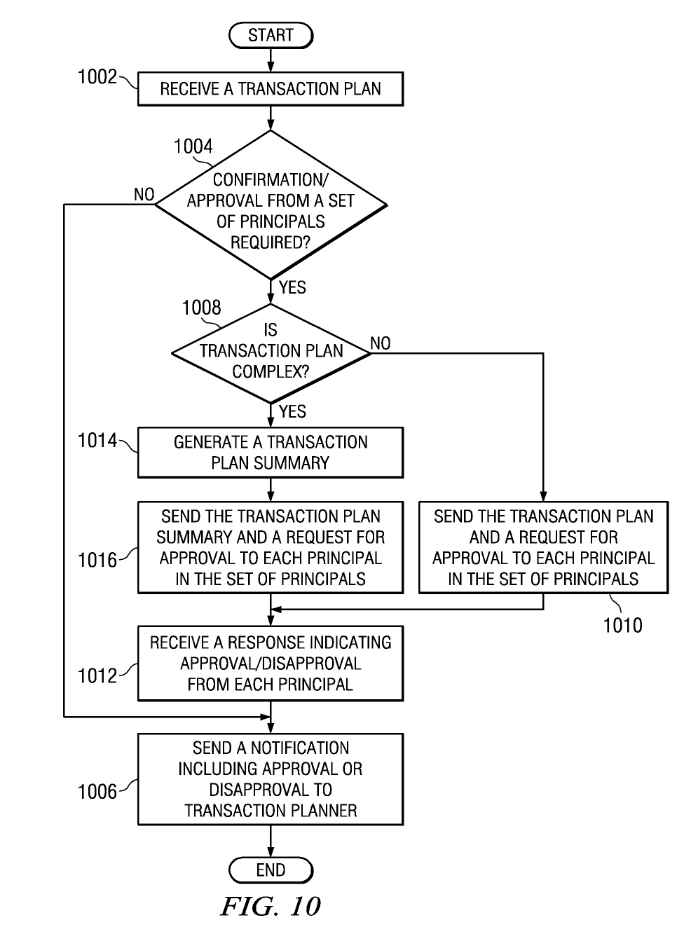

Referring now to FIG. 10, a flowchart illustrating an energy transaction plan approval process is shown in accordance with an illustrative embodiment. The process in FIG. 10 may be implemented by a software component for approving or disapproving an energy transaction plan, such as energy transaction plan approval service 312 in FIG. 3 or transaction plan approval service 402 in FIG. 4.

The process begins by receiving a transaction plan (step 1002) from an energy transaction planner, such as energy transaction planner 404 in FIG. 4. The energy transaction plan approval service makes a determination as to whether the energy transaction plan requires confirmation or approval from a set of principals (step 1004). The energy transaction plan approval service may not require confirmation or approval from any principals in the set of principals if the principals have sufficient contractual relationships to enable an autonomous approval process. If confirmation or approval is not required, the energy transaction plan approval service sends a notification indicating approval or disapproval of the energy transaction plan to the energy transaction planner (step 1006) with the process terminating thereafter.

Returning to step 1004, if confirmation or approval from one or more principals in the set of principals is required, the energy transaction plan approval service makes a determination as to whether the transaction plan is complex (step 1008). The transaction plan may be complex if the electric vehicle charging transaction includes complex charging, de-charging, and/or electric power storing phases. If the transaction plan is not complex, the energy transaction plan approval service sends the transaction plan and a request for approval to each principal in the set of principals (step 1010). The transaction plan and the request are displayed to each principal. The request asks the principal to approve or disapprove of the transaction plan. The energy transaction plan approval service receives a response from each principal indicating approval or disapproval of the transaction plan (step 1012). The energy transaction plan approval service either approves or disapproves of the transaction plan based on the responses received from the set of principals. The energy transaction plan approval service sends a notification indicating approval or disapproval of the plan to the energy transaction planner (step 1006) with the process terminating thereafter.

Returning to step 1008, if the transaction plan is complex, the energy transaction plan approval service generates a transaction plan summary, such as transaction plan summary 900 in FIG. 9 (step 1014). The energy transaction plan approval service sends the transaction plan summary and a request for approval to each principal in the set of principals (step 1016). The energy transaction plan approval service receives a response indicating approval or disapproval of the transaction plan from each principal (step 1012). The energy transaction plan approval service sends a notification indicating approval or disapproval of the transaction plan to an energy transaction planner (step 1006) with the process terminating thereafter.

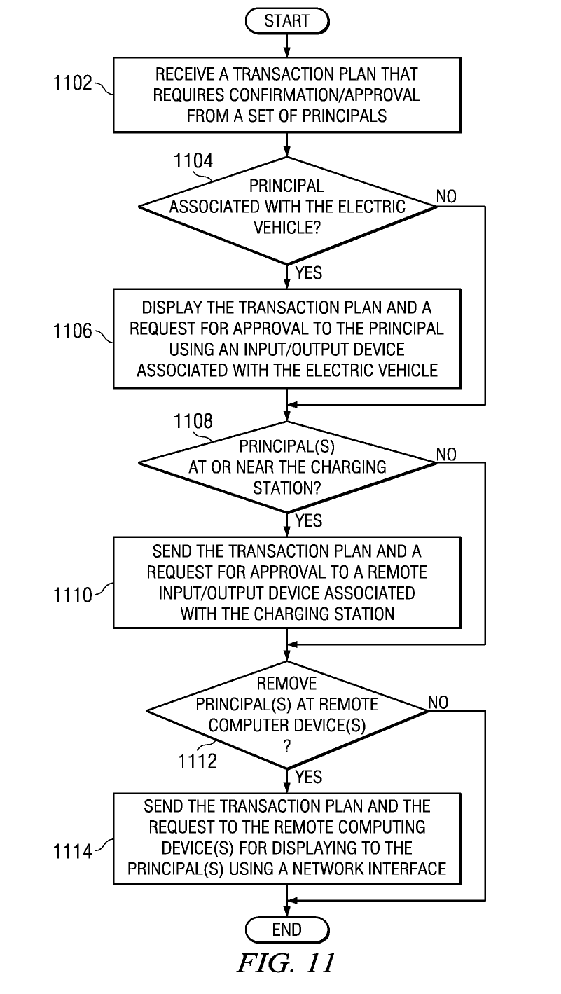

FIG. 11 is a flowchart illustrating a process for obtaining confirmation from a principal in accordance with an illustrative embodiment. The process in FIG. 11 may be implemented by a software component for approving or disapproving an energy transaction plan, such as energy transaction plan approval service 312 in FIG. 3 or transaction plan approval service 402 in FIG. 4.

The process begins by receiving a transaction plan that requires confirmation or approval from a set of principals (step 1102). The energy transaction plan approval service makes a determination as to whether one or more principals in the set of principals are associated with the electric vehicle (step 1104). If one or more principals are associated with the electric vehicle, the energy transaction plan approval service displays the transaction plan and the request for approval to the one or more principals using an input/output device associated with the electric vehicle (step 1106). Displaying the transaction plan and the request may be displayed on a visual display device, presented in audio only, or presented with audio and visual content. For example, the transaction plan and request may be presented to the principal by a voice synthesizer making an audio request and providing audio content describing the transaction plan or the transaction plan and the request may be displayed on a display screen.

The energy transaction plan approval service makes a determination as to whether one or more principals in the set of principals at or near the charging station (step 1108). If one or more principals are at or near the charging station, the energy transaction plan approval service sends the transaction plan and the request for approval to the remote input/output device associated with the charging station (step 1110). The plan and the request may be sent using a wired or wireless connection to the remote input/output device.

The energy transaction plan approval service also makes a determination as to whether one or more principals are remote principals at one or more remote computing devices (step 1112). If one or more principals in the set of principals are remote, the energy transaction plan approval service sends the transaction plan and the request to the one or more remote computing devices for display to the one or more principals using a network interface (step 1114) with the process terminating thereafter.

The steps shown in FIG. 11 may be executed in a different order than the order shown in FIG. 11. The process may also skip one or more steps in FIG. 11. For example, if confirmation of the electric vehicle operator is the only confirmation that is required, the process may only involve executing steps 1102-1106. Likewise, the process in FIG. 11 may involve additional steps that are not shown in FIG. 11, such as authenticating the remote computing devices, authenticating an identity of one or more principals at the charging station, the electric vehicle, or the remote computing devices, encrypting the transaction plan and/or the request, or any other additional steps.

FIG. 12 is a flowchart illustrating a process for approving or disapproving energy transaction plans in accordance with an illustrative embodiment. The process in FIG. 12 may be implemented by a software component for approving or disapproving an energy transaction plan, such as energy transaction plan approval service 312 in FIG. 3 or transaction plan approval service 402 in FIG. 4.

The process begins by receiving a transaction plan (step 1202) from an energy transaction planner, such as energy transaction planner 310 in FIG. 3 or energy transaction planner 404 in FIG. 4. The energy transaction plan approval service makes a determination as to whether the transaction plan is approved (step 1204). The transaction plan may be pre-approved without requiring confirmation or approval from any principals or the transaction plan may be approved or disapproved based on input from one or more principals associated with the energy transaction plan. If the transaction plan is approved, the energy transaction plan approval service sends an approval notice to the energy transaction planner (step 1206) with the process terminating thereafter.

Returning to step 1204, if the transaction plan is disapproved, the energy transaction plan approval service sends a disapproval notice to the energy transaction planner (step 1208). The energy transaction plan approval service then makes a determination as to whether a modified transaction plan is received from the energy transaction planner (step 1210). If a modified transaction plan is not received, the process terminates thereafter. Returning to step 1210, if a modified transaction plan is received, the energy transaction plan approval service makes a determination as to whether the modified transaction plan is approved (step 1212). If the modified plan is approved, the energy transaction plan approval service sends an approval notice to the energy transaction planner (step 1206) with the process terminating thereafter.

Returning to step 1212, if the modified transaction plan is not approved, the energy transaction plan approval service sends a disapproval notice to the energy transaction planner (step 1208). The energy transaction plan approval service determines if another modified transaction plan is received (step 1210). If another modified plan is not received, the process terminates thereafter.

According to one embodiment of the present invention, a computer implemented method, apparatus, and computer program product for managing electric vehicle charging transactions is provided. A transaction plan approval service receives an energy transaction plan and an identification of a set of principals associated with the energy transaction plan from an energy transaction planner. In response to a determination that the energy transaction plan is pre-approved by the set of principals, an energy transaction plan approval service sends a notification to the energy transaction planner indicating that the energy transaction plan is approved to form an approved energy transaction plan. In response to a determination that the energy transaction plan requires express approval from a subset of principals in the set of principals, the transaction plan approval service sends a request for approval of the energy transaction plan to each principal in the subset of principals. In response to receiving an approval from the each principal in the subset of principals, the transaction plan approval service sends the notification to the energy transaction planner indicating that the energy transaction plan is approved to form the approved energy transaction plan. The approved energy transaction plan is sent to an execution engine for implementation.

The embodiments provide a system for approving or disapproving an energy transaction plan for managing all aspects of an electric vehicle charging transaction. The transaction plan approval service approves transaction plans autonomously or by obtaining approval from one or more principals via a user interface device. The transaction plan approval service may present the entire transaction plan to a principal or generate a simplified plan summary for presentation to the principal so that it will be easier for the principal to understand the transaction plan. The transaction plan or plan summary may be presented to a principal using an input/output interface on an electric vehicle or using an input/output interface device that is external to the electric vehicle. The transaction plan approval service may obtain express approval of a transaction plan from a principal in real-time or provide an implicit approval from the principal based on the principal's preferences, contractual relationships, previous history/course of action, and/or other information available to the transaction plan approval service. The remote transaction plan approval service provides an approval service for multiple principals and reduces the communication costs to the on-board transaction plan approval service.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of approving energy transaction plans for managing electric vehicle charging transactions, the computer implemented method comprising:
receiving an energy transaction plan and an identification of a set of principals associated with the energy transaction plan from an energy transaction planner;
responsive to a determination that the energy transaction plan is pre-approved by the set of principals, sending a notification to the energy transaction planner indicating that the energy transaction plan is approved to form an approved energy transaction plan;
responsive to a determination that the energy transaction plan requires express approval from a subset of principals in the set of principals, sending a request for approval of the energy transaction plan to each principal in the subset of principals; and
responsive to receiving an approval from each principal in the subset of principals, sending the notification to the energy transaction planner indicating that the energy transaction plan is approved to form the approved energy transaction plan, wherein the approved energy transaction plan is sent to an execution engine for implementation.

2. The computer implemented method of claim 1 further comprising:
responsive to receiving a rejection of the energy transaction plan from at least one principal in the subset of principals, sending a notification to the energy transaction planner indicating that the energy transaction plan is rejected to form a rejected energy transaction plan, wherein the rejected energy transaction plan is not sent to the execution engine.

3. The computer implemented method of claim 1 further comprising:
responsive to a determination that the energy transaction plan is a complex plan generating a summary of the energy transaction plan, wherein a complex plan comprises a complex sequence of charge, discharge, and store events; and
sending the summary of the energy transaction plan with the request for approval of the transaction plan to the each principal in the subset of principals.

4. The computer implemented method of claim 1 further comprising:
presenting the energy transaction plan and the request for approval to a principal in the subset of principal on a user input/output interface on the electric vehicle.

5. The computer implemented method of claim 1 further comprising:
responsive to identifying a principal in the subset of principals at a remote computing device, sending the energy transaction plan and the request for approval of the energy transaction plan to the remote computing device using a network interface, wherein the remote computing device presents the energy transaction plan and the request for approval to the principal using a user input/output device on the remote computing device.

6. The computer implemented method of claim 1 further comprising:
responsive to identifying a principal in the subset of principals at a charging station connected to the electric vehicle, sending the energy transaction plan and the request for approval of the energy transaction plan to a user input/output device associated with the charging station through a physical connection to the charging station, wherein the physical connection is a connection through a power charge/discharge connection connecting the electric vehicle to the charging station.

7. The computer implemented method of claim 1 wherein the transaction plan approval service is an on-board energy transaction plan approval service located on-board the electric vehicle, and further comprising:
sending the energy transaction plan and the request for approval to a remote energy transaction plan approval service located on a server that is remote to the electric vehicle, wherein the remote energy transaction plan approval service obtains a response to the request from at least one principal in the subset of principals;
receiving the response from the at least one principal in the subset of principals from the remote energy transaction plan approval service;
sending the request to at least one other principal in the subset of principals by the on-board energy transaction plan approval service;
receiving a response from the at least one other principal in the subset of principals by the on-board energy transaction plan approval service;
determining whether the energy transaction plan is approved or rejected based on the response received from the remote energy transaction plan approval service and the response received from the at least one other principal; and
sending the notification to the energy transaction planner indicating whether the energy transaction plan is approved or rejected.

8. The computer implemented method of claim 1 wherein the transaction plan approval service is an on-board energy transaction plan approval service located on-board the electric vehicle, and further comprising:
sending the energy transaction plan and the request for approval to a remote energy transaction plan approval service located on a server that is remote to the electric vehicle, wherein the remote energy transaction plan approval service obtains a response to the request from every principal in the subset of principals and determines whether the energy transaction plan is approved or rejected;
receiving a notification indicating whether the energy transaction plan is approved or rejected from the remote energy transaction plan; and
sending the notification to the energy transaction planner, wherein the on-board energy transaction plan approval service is a proxy between the energy transaction planner and the remote energy transaction plan approval service.

9. The computer implemented method of claim 1 further comprising:
responsive to failing to obtain an express approval or rejection of the energy transaction plan from a principal in the subset of principals, analyzing at least one of preferences selected by the principal, a past history and course of conduct, and contractual relationships between the principals to determine whether the principal would have approved the energy transaction plan in an absence of express approval or express rejection; and
responsive to a determination that the principal would have provided express approval of the energy transaction plan, providing an implied approval of the energy transaction plan on behalf of the principal, by the transaction plan approval service.

10. A computer program product comprising:
a computer usable medium including computer usable program code for approving energy transaction plans for managing electric vehicle charging transactions, said computer program product comprising:
computer usable program code for receiving an energy transaction plan and an identification of a set of principals associated with the energy transaction plan from an energy transaction planner;
computer usable program code for sending a notification to the energy transaction planner indicating that the energy transaction plan is approved to form an approved energy transaction plan in response to a determination that the energy transaction plan is pre-approved by the set of principals;
computer usable program code for sending a request for approval of the energy transaction plan to each principal in a subset of principals in response to a determination that the energy transaction plan requires express approval from the subset of principals; and
computer usable program code for sending the notification to the energy transaction planner indicating that the energy transaction plan is approved to form the approved energy transaction plan in response to receiving an approval from the each principal in the subset of principals, wherein the approved energy transaction plan is sent to an execution engine for implementation.

11. The computer program product of claim 10 further comprising:
computer usable program code for sending a notification to the energy transaction planner indicating that the energy transaction plan is rejected to form a rejected energy transaction plan in response to receiving a rejection of the energy transaction plan from at least one principal in the subset of principals, wherein the rejected energy transaction plan is not sent to the execution engine.

12. The computer program product of claim 10 further comprising:
computer usable program code for generating a summary of the energy transaction plan in response to a determination that the energy transaction plan is a complex plan, wherein a complex plan comprise a complex sequence of charge, discharge, and store events; and
computer usable program code for sending the summary of the energy transaction plan with the request for approval of the transaction plan to the each principal in the subset of principals.

13. The computer program product of claim 10 further comprising:
computer usable program code for presenting the energy transaction plan and the request for approval to a principal in the subset of principal on a user input/output interface on the electric vehicle.

14. The computer program product of claim 10 further comprising:
computer usable program code for sending the energy transaction plan and the request for approval of the energy transaction plan to a user input/output device associated with the charging station through a physical connection to a charging station in response to identifying a principal in the subset of principals at the charging station connected to the electric vehicle, wherein the physical connection is a connection through a power charge/discharge connection connecting the electric vehicle to the charging station.

15. The computer program product of claim 10 wherein the transaction plan approval service is an on-board energy transaction plan approval service located on-board the electric vehicle and further comprising:
computer usable program code for sending the energy transaction plan and the request for approval to a remote energy transaction plan approval service located on a server that is remote to the electric vehicle, wherein the remote energy transaction plan approval service obtains a response to the request from at least one principal in the subset of principals;
computer usable program code for receiving the response from the at least one principal in the subset of principals from the remote energy transaction plan approval service;
computer usable program code for sending the request to at least one other principal in the subset of principals from the on-board energy transaction plan approval service;
computer usable program code for receiving a response from the at least one other principal in the subset of principals by the on-board energy transaction plan approval service;
computer usable program code for determining whether the energy transaction plan is approved or rejected based on the response received from the remote energy transaction plan approval service and the response received from the at least one other principal; and
computer usable program code for sending the notification to the energy transaction planner indicating whether the energy transaction plan is approved or rejected.

16. The computer program product of claim 10 wherein the transaction plan approval service is an on-board energy transaction plan approval service located on-board the electric vehicle and further comprising:
computer usable program code for sending the energy transaction plan and the request for approval to a remote energy transaction plan approval service located on a server that is remote to the electric vehicle, wherein the remote energy transaction plan approval service obtains a response to the request from every principal in the subset of principals and determines whether the energy transaction plan is approved or rejected;
computer usable program code for receiving a notification indicating whether the energy transaction plan is approved or rejected from the remote energy transaction plan; and
computer usable program code for sending the notification to the energy transaction planner, wherein the on-board energy transaction plan approval service is a proxy between the energy transaction planner and the remote energy transaction plan approval service.

17. An apparatus comprising:
a bus system;
a communications system coupled to the bus system;
a memory connected to the bus system, wherein the memory includes computer usable program code; and
a processing unit coupled to the bus system, wherein the processing unit executes the computer usable program code to receive an energy transaction plan and an identification of a set of principals associated with the energy transaction plan from an energy transaction planner; send a notification to the energy transaction planner indicating that the energy transaction plan is approved to form an approved energy transaction plan in response to a determination that the energy transaction plan is pre-approved by the set of principals; send a request for approval of the energy transaction plan to each principal in a subset of principals in response to a determination that the energy transaction plan requires express approval from the subset of principals in the set of principals; and send the notification to the energy transaction planner indicating that the energy transaction plan is approved to form the approved energy transaction plan in response to receiving an approval from the each principal in the subset of principals, wherein the approved energy transaction plan is sent to an execution engine for implementation.

18. A system for approving energy transaction plans for managing electric vehicle charging transactions, the system comprising:
an energy transaction planner, wherein the energy transaction planner sends an energy transaction plan and an identification of a set of principals associated with the energy transaction plan to an energy transaction plan approval service;
the energy transaction approval service, wherein the energy transaction approval service sends a notification to the energy transaction planner indicating that the energy transaction plan is approved to form an approved energy transaction plan in response to a determination that the energy transaction plan is pre-approved by the set of principals, wherein the energy transaction plan approval service sends a request for approval of the energy transaction plan to each principal in a subset of principals in response to a determination that the energy transaction plan requires express approval from the subset of principals in the set of principals; and sends the notification to the energy transaction planner indicating that the energy transaction plan is approved to form the approved energy transaction plan in response to receiving an approval from the each principal in the subset of principals, wherein the approved energy transaction plan is sent to an execution engine for implementation.

19. The system of claim 18 further comprising:
a summary generator, wherein the summary generator generates a summary of the energy transaction plan in response to a determination that the energy transaction plan is a complex plan, wherein a complex plan comprises a complex sequence of charge, discharge, and store events; and wherein the summary generator sends the summary of the energy transaction plan with the request for approval of the transaction plan to the each principal in the subset of principals.

20. The system of claim 18 wherein the transaction plan approval service is an on-board energy transaction plan approval service located on-board the electric vehicle and further comprising:
a remote energy transaction plan approval service located on a server that is remote to the electric vehicle, wherein the remote energy transaction plan approval service receives the energy transaction plan and the request for approval from the on-board energy transaction plan approval service and obtains a response to the request from every principal in the subset of principals; determines whether the energy transaction plan is approved or rejected; and wherein the remote energy transaction plan approval service sends a notification indicating whether the energy transaction plan is approved or rejected to the on-board energy transaction plan approval service, wherein the on-board energy transaction approval service sends the notification to the energy transaction planner, wherein the on-board energy transaction plan approval service is a proxy between the energy transaction planner and the remote energy transaction plan approval service.
